(19) United States
(12) Patent Application Publication
(10) Pub. No.: US 2003/0204477 A1
(43) Pub. Date: Oct. 30, 2003

(54) Mail processing system

(76) Inventor: John C. McNett, West Lafayette, IN (US)

Correspondence Address: Charles P. Schmal, Woodard, Emhardt, Naughton, Moriarty and McNett, Bank One Center/Tower, 111 Monument Circle, Suite 3700, Indianapolis, IN, 46204-5137, US

(21) Appl. No.: 10/128,830

(22) Filed: Apr. 24, 2002

(51) Int. Cl. G06G 7/00; G06F 17/00; G07B 17/02; B65B 35/00

(52) U.S. Cl. 705/406

(57) ABSTRACT

A mail processing system for processing bulk mailings includes a mail processing device and a scale operatively coupled to the device. The scale includes a bin with an opening for holding bulk mailings. A sensor is operatively coupled to the mail processing device, and the sensor is operable to send a signal to mail processing device in response to movement of a piece of mail through the opening of the bin. The processor is operable to determine a weight of the piece of mail by comparing weight of the bin before and after receiving the signal from the sensor. The mail can be loaded and removed from the bin manually or automatically. The mail processing system can print a manifest containing the postage for the individually weighed pieces of mail and/or print the appropriate postage on each piece of mail.

### BACKGROUND OF THE INVENTION

The present invention generally relates to mail processing systems that are based on differential weighing of mail pieces in order to determine posting charges.

U.S. Pat. No. 5,001,648 to Baker discloses the pioneering invention of differential weighing, in which posting charges can readily be determined for multiple pieces of mail by looking at sequential stabilized changes in weight of a stack of mail as each piece of mail is sequentially removed. This technique has been widely adopted throughout the world to increase the efficiency of the posting and manifesting processes. The invention requires time to pass to achieve stabilization, and various environmental influences can affect the stabilization, such as air flow, vibration, insects, etc.

An alternative to the use of a stabilized weight is the use of a push button, manually operated by the operator each time a mail piece is removed. This requires the operator to significantly interrupt the smooth flow of mail processing in order to push the button each time a mail piece is removed. Thus, there remains a need for an improved technique and system for quickly processing bulk mailings using a differential weighing technique, but without depending exclusively on a measured stabilized weight.

### SUMMARY OF THE INVENTION

In one form of the present invention, there is provided a sensor to detect the presence of a hand or arm positioned to remove a mail piece without the need for the hand or arm to press a mechanical button each time a mail piece is removed. Initially a first weight of a mail collection is measured with a weighing device that is operatively coupled to a processor. With the sensor operatively coupled to a processor, after measuring the first weight, the processor responds to the sensor and then after the manual removal has occurred, measures a second weight of the mail collection. The processor determines weight of the removed piece of mail based on a difference between the first weight and the second weight.

Another form of the present invention concerns an apparatus that includes means for recording a first weight of a group of bulk mailings and means for sensing manual removal of a piece of mail from the group by a person. The apparatus further includes means for recording a second weight of the group in response to sensing the presence of a hand or arm for removing the piece of mail and means for recording postage for the piece of mail based on the first weight and the second weight.

A system according to a further form of the present invention includes a processor and a scale operatively coupled to the processor. The scale is adapted to weigh bulk mailings. A sensor is operatively coupled to the processor, and the sensor is operable to send a signal to the processor in response to removal of a piece of mail from the bulk mailings by a hand. The processor is operable to determine a weight of the piece of mail by comparing weight of the bin before and after receiving the signal from the sensor.

In a further form, a weighing device that is operatively coupled to a processor measures a first weight of a bin with an opening. After the measuring the first weight, a sensor that is operatively coupled to the processor detects movement of a piece of mail through the opening of the bin. The weighing device measures a second weight of the bin in a manner, which is linked to detecting movement. The processor determines weight of the piece of mail based on the difference between the first weight and the second weight.

Other forms, embodiments, objects, features, advantages, benefits and aspects of the present invention shall become apparent from the detailed drawings and description contained herein.

### BRIEF DESCRIPTION OF THE DRAWINGS

FIG. 1 is a diagrammatic view of a mail processing system according to one embodiment of the present invention.

FIG. 2 is a diagrammatic view of a mail processing system according to another embodiment of the present invention.

FIG. 3 is a diagrammatic view of a mail processing system according to a further embodiment of the present invention.

FIG. 4 is a flow diagram illustrating a mail processing technique according to one embodiment of the present invention.

FIG. 5 is a flow diagram illustrating a mail processing technique according to another embodiment of the present invention.

### DESCRIPTION OF SELECTED EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

The general operational features of mail processing systems are widely known, and therefore, will not be discussed in depth for the sake clarity. For instance, U.S. Pat. No. 5,001,648 to Baker (issued on Mar. 19, 1991), which is hereby incorporated by reference in its entirety, discloses various types of mail processing systems which can be readily modified for use with this invention.

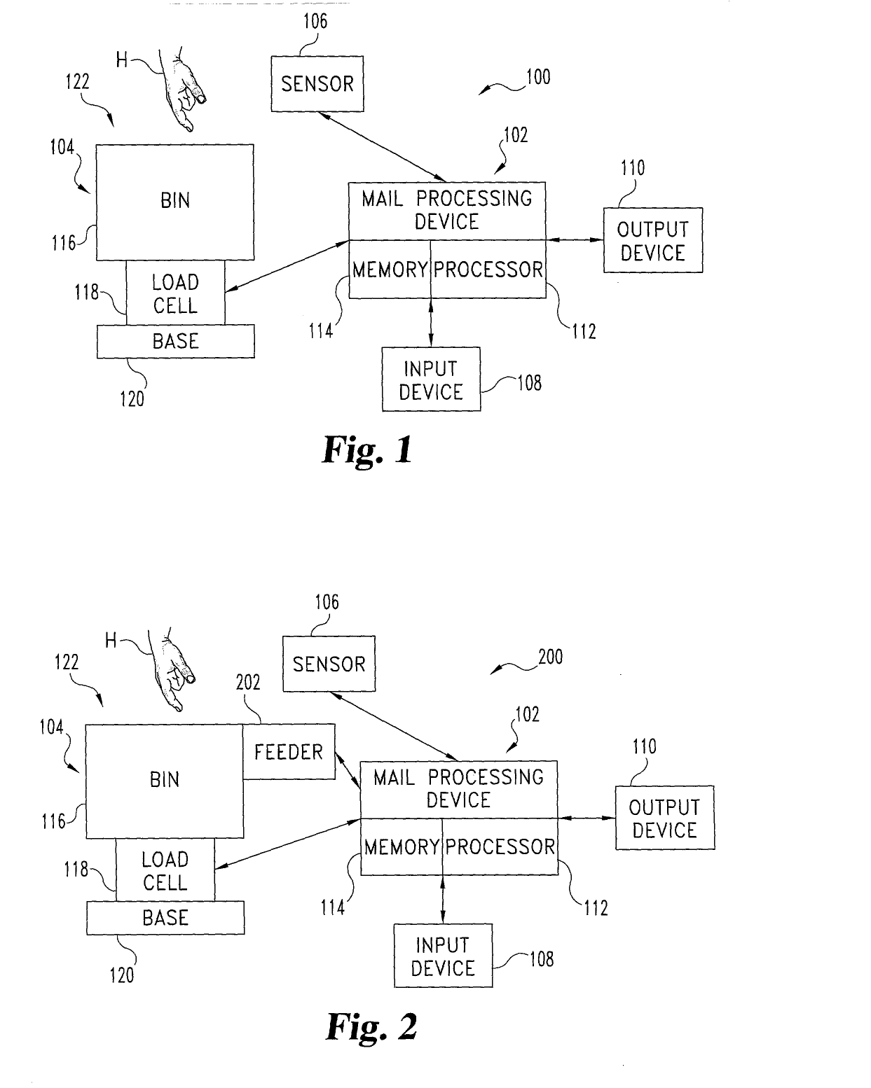

FIG. 1 illustrates a mail processing system 100 according to one embodiment of the present invention in a diagrammatic form. As shown, the system 100 includes a mail processing device 102 and a weighing device 104 that is operatively coupled to the mail processing device 102. System 100 further includes at least one sensor 106, input device 108 and output device 110, all operatively coupled to the mail processing device 102. The above-discussed components can be separate or integrated into a single unit.

As depicted in FIG. 1, the mail processing device 102 includes a processor 112 and memory 114. The mail processing device 102 can include a personal computer, a computer terminal, a personal digital assistant (PDA), a postage meter and/or other types of devices generally known to those skilled in the art. In one embodiment, the mail processing device 102 is a personal computer encoded with software that performs the mail processing techniques as described below, while in another embodiment, the mail processing device 102 is a postage meter with functionality to calculate postage in accord with the differentially determined weight applied to the postage regulations. The processor 112 is used to control the operation of the mail processing device 102. The processor 112 may be comprised of one or more components. For a multi-component form of processor 112, one or more components may be located remotely relative to the others, or configured as a single unit. Furthermore, processor 112 can be embodied in a form having more than one processing unit, such as a multi-processor configuration, and should be understood to collectively refer to such configurations as well as a single-processor-based arrangement. One or more components of the processor 112 may be of electronic variety defining digital circuitry, analog circuitry, or both. Processor 112 can be of a programmable variety responsive to software instructions, a hardwired state machine, or a combination of these. Among its many functions, the memory 114 in conjunction with the processor 112 is used to store and calculate postal rates. Further, memory 114 can store manifests or reports, which can be transferred to the postal carrier. Memory 114 can include one or more types of solid state memory, magnetic memory, or optical memory, just to name a few. By way of nonlimiting example, the memory 114 can include solid state electronic random access memory (RAM), sequential access memory (SAM) (such as first-in, first-out (FIFO) variety or last-in, first-out (LIFO) variety), programmable read-only memory (PROM), electronically programmable read only memory (EPROM), or electronically erasable programmable read only memory (EEPROM); flash memory, an optical disk memory (such as a DVD or CD-ROM); a magnetically encoded hard disk, floppy disk, tape, or cartridge medium; or a combination of these memory types, or the like. In addition, the memory 114 may be volatile, nonvolatile, or a hybrid combination of volatile and non-volatile varieties, and memory 114 can be in the form of removable memory. Memory 114, when removable, can be in the form of a non-volatile electronic memory unit, optical memory disk (such as a DVD or CD ROM); a magnetically encoded hard disk, floppy disk, tape, or cartridge medium; or a combination of these or other removable memory types.

As depicted in FIG. 1, the weighing device 104 includes a bin 116, a load cell 118 and a base 120. The weighing device 104 measures the weight of pieces of mail in the bin 116. It should be noted that, as used in this description, “envelope,” “mail,” “mail piece,” “package,” and “mail carrier” refer to any letter, parcel, or other matter that is intended to be processed in a mail delivery system. The weighing device 104 can be a postage scale, electronic scale, or other types of weight or mass measuring devices as generally known by those skilled in the art. The bin 116 can be permanently attached to the load cell 118 or removably coupled to the load cell 118. Envelopes, boxes, parcels and other pieces of mail are contained in the bin 116. As shown, the base 120 supports the load cell 118 of the weighing device 104. The load cell 118 provides an output signal in proportion to the load or weight placed upon the load cell 118 by the bin 116 and its contents, if any. As should be appreciated, the output signal can be in an analog form, a digital form or a combination thereof. The output signal from the load cell 118 is processed by the processor 112 of the mail processing device 102.

The sensor 106 monitors the bin 116 in order to sense when pieces of mail are being removed or added to the bin 116. In the illustrated embodiment, an operator with hand H manually removes individual pieces of mail from the bin 116 in order to apply postage to the removed piece of mail. The sensor 106 is operable to sense when the operator places their hand H, arm, or some other appendage into the bin 116 in order to remove mail from the bin. The sensor 106 can include, but is not limited to, infrared (IR) sensors, light sensors, magnetometers, ultrasonic sensors, heat sensors, thermal imaging, motion sensors, microwave, capacitance-type sensors, proximity detection sensors (“prox switches”) and the like. In the illustrated embodiment, sensor 106 is positioned proximal to opening 122 of the bin 116 in order to detect the removal or loading pieces of mail into the bin 116. Although one sensor 106 is shown, it should be appreciated that system 100 can contain multiple sensors 106. In one embodiment, an array of sensors 106 form a light curtain in order to detect the operator reaching into the bin 116. In another embodiment, an ultrasonic motion sensor 106 is used to detect the removal of a piece of mail. Further, in other forms, the bin 116 can contain multiple openings through which mail is loaded into and/or removed from the bin 116, or may be even a planar platform. It should be noted that, as used in this description, “bin” can include any structure capable of supporting one or more pieces of mail.

When the sensor 106 senses movement around opening 122, the sensor 106 sends a signal to the processing device 102 to alert the processing device that a mail piece may have been loaded into or removed from the bin 116. For example, an operator will activate the sensor 106 when the operator sticks their arm into the bin 116 during mail removal. Further, the sensor 106 senses when pieces of mail are dumped into the bin 116. The mail processing device 102 can determine the weight of individual pieces of mail using a number of techniques. In the preferred “removal” mode of operation, the mail processing device 102 determines the weight of individual mail pieces as the pieces are removed one by one from the bin 116 by determining the difference in bin weight before and after the individual mail pieces are removed. In a “loading” mode of operation, the mail processing device 102 determines the weight of mail pieces as the pieces are individually loaded into the bin 116. As compared to the “loading” mode of operation, the “removal” mode of operation requires fewer steps in order to apply postage to the mail.

The input device 108 is used to control and enter information into the mail processing device 102. The input device 108 can include, but is not limited to, a keyboard, mouse, trackball, electronic tablet, barcode scanner, microphone, camera and the like along with other types of input devices as generally known by those skilled in the art. In one embodiment, the input device 108 includes a keyboard. The output device 110 is used to provide information to the operator and further can print information, such as postage, on the mail, labels, forms, plain paper or other medium. Moreover, in another embodiment, the output device 110 can generate a unique identifier that is applied to the mail along with a manifest. The output device 110 can include, but is not limited to, computer displays, printers, speakers, and the like. In one embodiment, system 100 includes at least two output devices, a computer monitor and a printer for printing postage on the individual mail pieces.

Although FIG. 1 illustrates only individual components, it should be appreciated that system 100 can include multiple numbers of the above-described components. Further, the components of system 100 can be located remotely relative to one another and can be operatively coupled to one another through hardwired connections, wireless connections, or a combination thereof. For example, multiple weighing devices 104 can be operatively coupled to the mail processing device 102 over a network.

A mail processing system 200 according to another embodiment of the present invention is illustrated in FIG. 2. Similar to the FIG. 1 embodiment, system 200 includes weighing device 104, sensor 106, input device 108 and output device 110, all of which are operatively coupled to the mail processing device 102. As shown in FIG. 2, system 200 further includes a mail feeder 202 positioned proximal to the bin 116 for feeding mail into and/or out of the bin 116. The feeder 202 is operatively coupled to the mail processing device 102 in order to send a signal indicating that mail has been fed into or out of the bin 116. In one form of the present invention, in addition to monitoring opening 122, sensor 106 monitors mail being fed by the feeder 202.

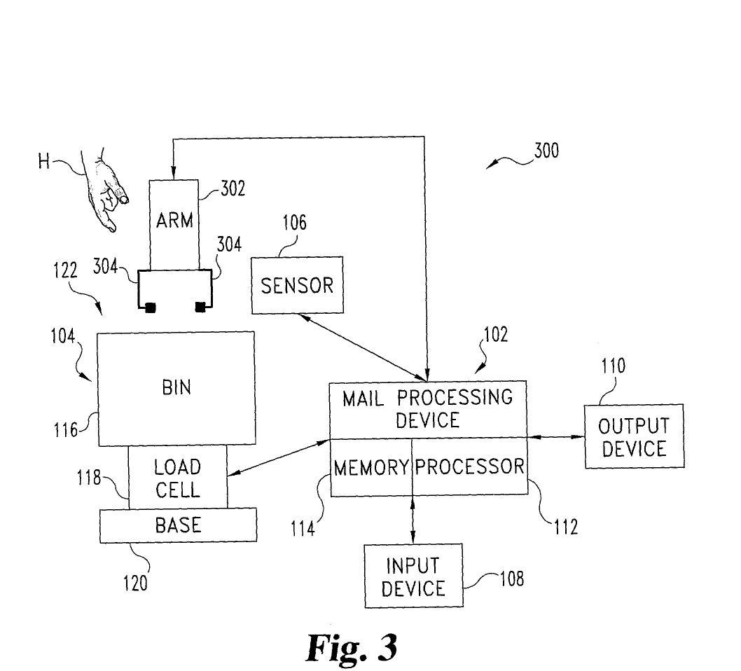

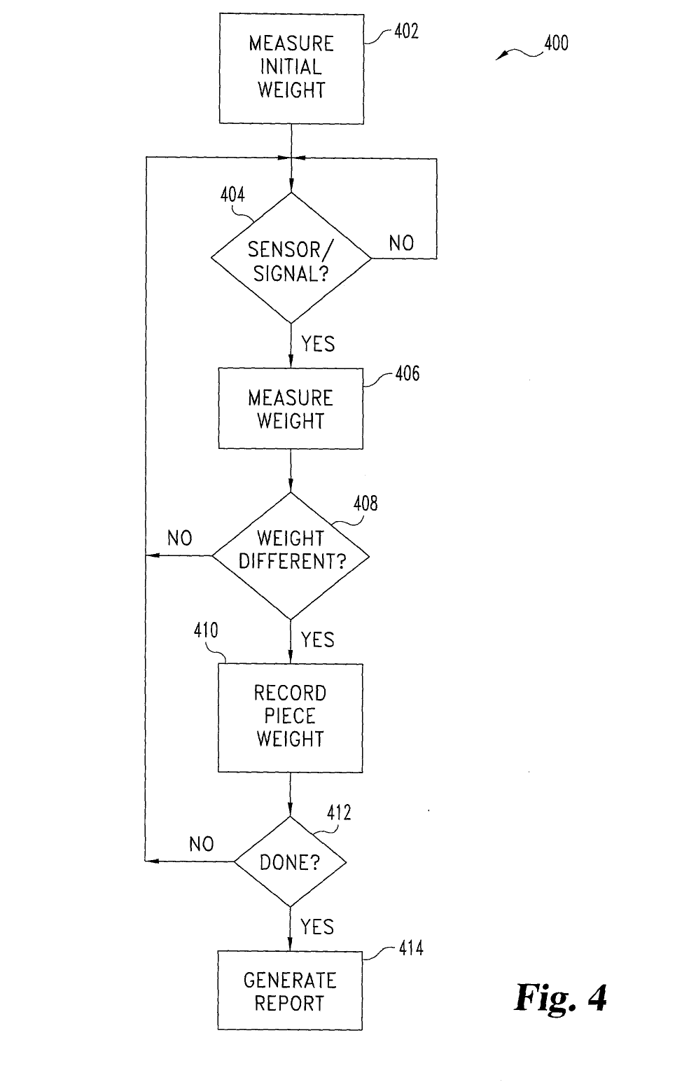

FIG. 3 illustrates a mail processing system 300 according to a further embodiment of the present invention that is adapted to automatically handle pieces of mail having various dimensions and weights. The mail processing system 300 illustrated in FIG. 3 includes weighing device 104, sensor 106, input device 108 and output device 110, all of which are operatively coupled to the mail processing device 102. To remove and/or load pieces of mail into the bin 116, system 300 includes a robotic arm 302. The arm has gripping members or hand 304 that are adapted to handle pieces of mail having varying sizes, weights or dimensions. In the illustrated embodiment, the arm 302 is operatively coupled to the mail processing device 102 in order to send a signal to the mail processing device 102 indicating whether a piece of mail has been removed from or loaded into the bin 116 by the robotic arm 302. Alternatively or additionally, sensor 106 can monitor removal or loading of mail pieces in the bin 116 by the arm 302. In one form, the sensor 106 monitors the opening 122 of the bin 116 in order to detect manual removal or loading of mail.

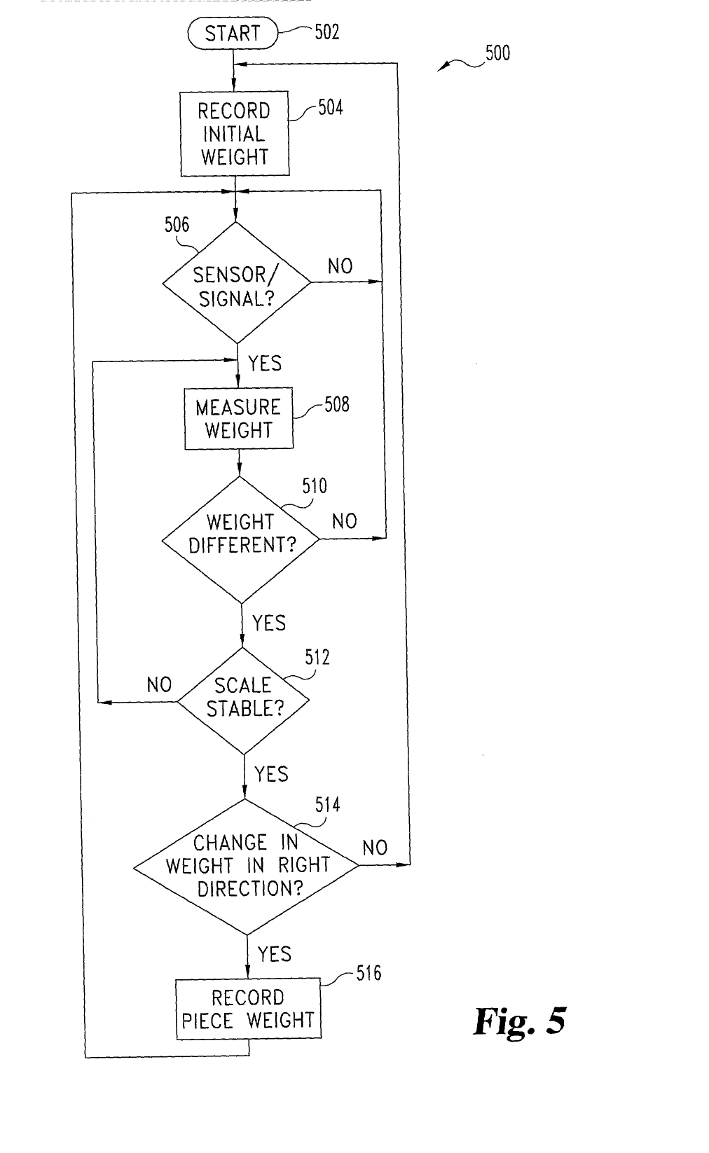

A technique for processing mail according to one embodiment of the present invention will now be described with reference to flowchart 400 in FIG. 4, with continuing reference to elements shown in FIGS. 1-3. The technique illustrated in FIG. 4 can be used, for example, with any of the systems 100, 200 or 300 that were described above with reference to FIGS. 1-3. The technique illustrated in flowchart 400 can be used determine mail piece weight when pieces are being added or removed from the bin. For explanation purposes, the technique will be described with respect to the “removal” weight determination mode (or technique), in which the weight of individual pieces of mail are determined upon removal from the bin 116. It should be understood that the technique illustrated in FIG. 4 can also be used with the “loading” weight determination mode (or technique), in which the weights of individual pieces of mail are determined as they are loaded one by one into the bin 116. In the “removal” weight determination mode of operation, the bin 116 is initially loaded with a number of pieces of mail. In stage 402, the load cell 118 sends a signal corresponding to the initial weight of the bin 116 to the mail processing device 102, and the processor 112 stores in memory 114 the initial weight of the bin 116. In stage 404, the mail processing device 102 determines whether or not a signal has been received indicating the possible removal of mail from the bin 116. In one embodiment, the sensor 106 sends a signal to the mail processing device 122 whenever the sensor 106 senses activity around the opening 122 of the bin 116. For example, in the FIG. 1 embodiment, if the operator reaches into the bin 116 to remove a piece of mail, the sensor 106 will send a signal to the mail processing device 102 to alert device 102 that a piece of mail is being removed. In the FIG. 2 embodiment, the feeder 202 can send a signal to the mail processing device 102 when the feeder 202 feeds a piece of mail from the bin 116. As should be appreciated, the sensor 106 in system 200 can at the same time monitor pieces of mail being removed manually and/or monitor mail being discharged from the feeder 202. In the FIG. 3 embodiment, the sensor 106 sends a signal when pieces are removed manually by the operator and/or when pieces are being removed by the robotic arm 302. Alternatively or additionally, the robotic arm 302 can send a signal to the mail processing device 102 when the arm 302 removes a piece of mail from the bin 116. If the mail processing device 102 in stage 404 does not receive a signal indicating activity in or around the bin 116 (i.e., from sensor 106, feeder 202 or arm 302), the processor 112 continues to monitor for a signal.

Once a signal is received in stage 404, for example from sensor 106, the mail processing device 102 determines from the load cell 118 the current weight of the bin 116 in stage 406. In another embodiment, the mail processing device 102 in stage 406 waits a predetermined length of time and/or waits until the weight of the bin 116 has stabilized before reading the weight of the bin 116. It should be understood that scale stability may be based on maximum load cell resolution or use a tolerance. The processor 112 determines in stage 408 whether the weight of the bin 116 has changed. If the weight of the bin 116 has not changed in stage 408, then the mail processing device 102 continues to monitor for activity signals in stage 404. This may occur, for example, if the operator accidentally sticks hand H into the bin 116 without removing any mail from the bin 116. In another embodiment of the present invention, stage 408 is omitted. When the weight of the bin 116 has changed in stage 408, the processor 112 of the mail processing device 102 records in memory 114 the weight of the piece removed from the bin 116. Alternatively or additionally, the postage for the removed piece of mail can be recorded in memory 114 and/or recorded on the piece of mail during stage 410. The processor 112 in stage 410 calculates the postage for the piece of mail based on the weight of the removed piece of mail and the postal rate stored in memory 114. In one embodiment, during stage 410, the output device 110 places the postage on the piece of mail that has been removed from the bin 116. In one form, the output device 110 includes a label printer that prints a label containing the postage, which is affixed the to removed piece of mail. In another form, the output device 110 directly imprints the postage on the piece of mail. The processor 112 in a further embodiment does not proceed from stage 410 until the postage has been applied the piece of mail.

In stage 412, the mail processing device 102 determines whether or not the operator is finished. If so, the mail processing device 102 can generate a manifest or some other type of report in stage 414. In one embodiment, the operator can enter a command through input device 108 in order to indicated completion of mail processing. In another embodiment, the mail processing device 102 automatically proceeds to stage 414 when the weight of the bin 116 indicates that the bin 116 is empty. It should be understood that stage 414 is optional such that no report has to be generated when the operator is finished processing the mail. In stage 414, the processor 112 can store an electronic version of the manifest in memory 114 and/or print a hard copy of the report via output device 110. The electronic report in memory 114 can be transferred physically, such as through a floppy disk, and/or transferred electronically over a computer network. It should be understood that the above technique can be modified so that the reports can be printed at other stages. If the mail processing device 102 is not finished processing mail in stage 412, the processor 112 in stage 404 determines whether a signal has been received.

As mentioned above, although the technique illustrated with flowchart 400 was described in reference to the “removal” weight determination mode, the technique can also be used to with the “loading” weight determination mode. For instance, the sensor 106 can send a signal to device 102 in stage 404 when a piece of mail has been loaded into the bin 116. Further, when a piece of mail is loaded into the bin 116, the weight of the bin 116 in stage 408 will increase by the weight of the loaded piece of mail. In stage 410, the processor 112 records in memory 114 the increased weight as the weight of the piece of mail loaded into the bin 116.

A technique for processing mail according to another embodiment of the present invention is illustrated with flowchart 500 in FIG. 5, with continuing reference to elements shown in FIGS. 1-3. The illustrated technique allows pieces to be weighed on a continuous basis and provides for greater flexibility in processing mail. For example, the technique illustrated with flowchart 500 allows mail to be added to bin 116 while still determining weight through the “removal” technique. The technique of FIG. 5 also allows the weight of pieces being added one by one to the bin 116 through the “loading” weight technique to be determined even when pieces of mail are removed from the bin 116.

As shown in FIG. 1, after initializing the mail processing device in stage 502, the processor 112 using the weighing device 104 determines the initial weight of the bin 116 in stage 504. In stage 506, the mail processing device 102 determines whether a signal has been received that indicates activity around the bin 116. In the embodiment illustrated in FIG. 1, the sensor 106 for example sends a signal to the mail processing device 102 when an operator reaches into the opening 122 of the bin 116. In the embodiment illustrated in FIG. 2, the sensor 106 can send a signal to the mail processing device 102 when a person reaches into the bin 116 or when mail is fed with the feeder 202. Alternatively or additionally, the feeder 202 can send a signal to the mail processing device 102 when the feeder 202 feeds mail into or out of the bin 116. In the embodiment illustrated in FIG. 3, the sensor 106 can send a signal to the mail processing device 102 when a person reaches into the bin 116 or when mail is automatically moved with arm 302. Alternatively or additionally, the arm 302 can send a signal to the mail processing device 102 when the arm 302 moves mail into or out of the bin 116. If the mail processing device 102 does not receive a signal from the sensor 106, the feeder 202 and/or the arm 302 in stage 506, the processor 112 of device 102 continues to monitor for an activity signal in stage 506. When such a signal is received, the mail processing device 102 using weighing device 104 measures the weight of the bin 116. The processor 112 of device 102 determines whether the weight of the bin 116 has changed in stage 510. If the weight of the bin 116 has not changed, the mail processing device 102 continues to monitor for another signal in stage 506. When the weight of the bin 116 has changed, device 102 determines in stage 512 whether the weighing device 104 is stable. As should be appreciated, scale stability can be determined in stage 512 before the processor 112 determines whether there is a difference in weight in stage 510. If the weighing device 104 is determined to be unstable in stage 512, the weight of the bin 116 is determined again in stage 508. In another form of the present invention, where scale instability is not a concern, stage 512 is omitted. In a further embodiment, both stages 510 and 512 are omitted.

As shown in FIG. 5, when the weighing device 104 is stable in stage 512, the processor 112 in stage 514 determines whether the change of weight was caused by mail being added to or removed from the bin 116. If the weight has not changed in the direction corresponding to the weight determination mode (i.e. “removal” technique or “loading” technique), then the mail processing device 102 recalibrates to the new weight of the bin 116 in stage 504. If the weight of the bin 116 changes as expected, the processor 112 records in memory 114 the weight of the piece of mail added to or removed from the bin 116, depending on the current weight determination technique (mode). For example, when the mail processing device 102 uses the “removal” weight determination technique, the processor 112 determines in stage 514 whether the weight of the bin 116 has decreased, as occurs when mail has been removed, or has increased, as occurs when mail has been added to the bin 116. When the weight of the bin 116 increases, it is inferred that mail has been added to the bin 116, and therefore, the weight of the bin 116 has to be set to the higher weight in stage 504. In contrast, if the weight of the bin 116 decreases, it is inferred that a piece of mail has been removed in accordance with the “removal” operational mode so that the weight of the piece of mail removed from the bin 116 can be recorded in stage 516.

In another example, when the mail processing device 102 uses the “loading” weight determination technique, the processor 112 determines in stage 514 whether the weight of the bin 116 has increased, which occurs when mail has been added, or has decreased, which occurs when mail has been removed from the bin 116. When the weight of the bin 116 decreases in stage 514, the processor 112 recalibrates to the lower weight in stage 504. When the weight of the bin 116 has increased in accordance with the “loading” operational mode, the weight of the piece added is recorded in memory 114 in stage 516.

As mentioned above, the processor 112 in stage 516 records in memory 114 the weight of the individual piece of mail. Alternatively or additionally, the postage for the removed piece of mail can be recorded in memory 114 and/or recorded on the piece of mail during stage 516. In one embodiment, the output device 110 is used to apply the postage rates to the weighed pieces of mail. In another embodiment, when a manifest needs to be generated, the output device 110 applies a unique identifier, such as a serial number, to the individual pieces of mail. It should be understood that the output device 110 can be used to generate the unique identifier for a piece of mail before, during or after stage 516.

After stage 516, the mail processing device 102 monitors to see if another activity signal is received in stage 506. For the sake of clarity, flowchart 500 in FIG. 5 does not include report generation stages 412 and 414. It should be understood that the mail processing technique illustrated with flowchart 500 can include stages 412 and 414 so that any required reports can be generated.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A method, comprising:
measuring a first weight of a collection of mail pieces with a weighing device that is operatively coupled to a processor;
after said measuring the first weight, detecting manual removal of a piece of mail from the collection by sensing movement around the collection with a sensor operatively coupled to the processor;
measuring a second weight of the collection with the weighing device in response to said detecting manual removal; and
determining weight of the piece of mail with the processor based on a difference between the first weight and the second weight.

2. The method of claim 1, further comprising:
after said measuring the second weight, detecting manual removal of a second piece of mail from the collection;
measuring a third weight of the collection with the weighing device in response to said detecting manual removal of the second piece of mail; and
determining weight of the second piece of mail with the processor based on a difference between the second weight and the third weight.

3. The method of claim 2, further comprising:
determining postage with the processor for the second piece of mail based at least in part on the weight of the second piece of mail; and
applying the postage to the second piece of mail.

4. The method of claim 1, further comprising:
determining postage with the processor for the piece of mail based at least in part on the weight of the piece of mail; and
applying the postage to the piece of mail.

5. The method of claim 1, further comprising determining that the second weight is less than the first weight before said determining the weight of the piece of mail.

6. The method of claim 1, further comprising generating a manifest with an output device operatively coupled to the processor.

7. The method of claim 1, further comprising:
detecting bin weight stability with the processor before said measuring the second weight; and
determining a difference between the first weight and the second weight following said measuring the second weight.

8. The method of claim 1, further comprising providing the sensor, wherein the sensor includes a light curtain.

9. The method of claim 1, wherein the piece of mail includes a package.

10. An apparatus, comprising:
means for recording a first weight of a group of mail pieces;
means for touchless sensing of a hand positioned near said group of mail pieces;
means for recording a second weight of said group of mail pieces in response to sensing of the hand positioned near said group of mail pieces; and
means for recording postage for a piece of mail of said group of mail pieces based on said first weight and said second weight.

11. The apparatus of claim 10, further comprising:
means for determining said second weight is less than said first weight; and
said means for touchless sensing uses optical sensing.

12. An apparatus, comprising:
a processor;
a scale operatively coupled to said processor, said scale being adapted to weigh bulk mailings;
a sensor operatively coupled to said processor, said sensor being operable to send a signal to said processor in response to sensing a hand at some point in a process of removal of a piece from said bulk mailings; and
wherein said processor is operable to determine a weight of the piece by comparing weight of said bulk mailings before and after receiving the signal from said sensor.

13. The apparatus of claim 12, further comprising:
a bin coupled to said scale, said bin being adapted to hold said bulk mailings; and
a feeder coupled to said bin.

14. The apparatus of claim 12, further comprising a robotic arm incorporating said hand, said robotic arm being adapted to remove the piece from said bulk mailings.

15. The apparatus of claim 12, wherein said hand is a human hand.

16. The apparatus of claim 12, further comprising an output device operatively coupled to said processor, said output device being operable to generate a manifest.

17. The apparatus of claim 12, further comprising:
memory operatively coupled to said processor; and
wherein said processor is operable to record the weight of the piece of mail in said memory when the weight of said bulk mailings has reduced.

18. A method, comprising:
measuring a first weight of a bin with a weighing device that is operatively coupled to a processor, wherein the bin has an opening;
after said measuring the first weight, detecting movement of a piece of mail through the opening of the bin with a sensor that is operatively coupled to the processor;
measuring a second weight of the bin with the weighing device in response to said detecting movement; and
determining weight of the piece of mail with the processor based on the first weight and the second weight.

19. The method of claim 18, wherein:
said detecting movement includes sensing removal of the piece of mail from the bin; and
said determining the weight of the piece of mail includes computing the weight of the piece of mail based on a difference between the second weight and the first weight.

20. The method of claim 19, further comprising determining the second weight is less than the first weight before said determining the weight of the piece of mail.

21. The method of claim 18, further comprising feeding the piece of mail with a feeder coupled to the bin.

22. The method of claim 18, further comprising moving the piece of mail with a robotic arm positioned proximal the bin.

23. The method of claim 18, further comprising determining with the processor that a difference between the first weight and the second weight is in accordance with a weight determination mode for the processor.
